(19) United States
(12) Patent Application Publication
(10) Pub. No.: US 2012/0279070 A1
(43) Pub. Date: Nov. 8, 2012

(54) RAZOR COMPRISING A TEMPERATURE-SENSITIVE CAPSULE

(75) Inventor: Byoung Jun Seo, Gyeonggi-Do (KR)

(73) Assignee: DORCO CO., LTD., GYEONGGI-DO (KR)

(21) Appl. No.: 13/514,202

(22) PCT Filed: Jun. 17, 2010
(86) PCT No.: PCT/KR2010/003898

§ 371 Date: Jun. 22, 2012

(30) Foreign Application Priority Data
Dec. 30, 2009 (KR) 10-2009-0133541

(51) Int. Cl. B26B 21/40; B26B 21/44

(52) U.S. Cl. 30/34.2; 30/34.05

(57) ABSTRACT

The present invention relates to a razor, and particularly, to a razor the color of which changes in accordance with water temperature. The razor comprises: a razor cartridge to which a plurality of blades are coupled; and a handle coupled to the cartridge, wherein a temperature-sensitive capsule is embedded in the cartridge or in the handle such that the temperature of the temperature-sensitive capsule changes when the water temperature becomes higher than a specific temperature level.

### TECHNICAL FIELD

The present invention relates to a razor, and more particularly, to a razor the color of which changes in accordance with water temperature.

### BACKGROUND ART

There are many attempts in the razor field to enable easier cutting of body hair. A lot of researches have been conducted to improve the performance of a blade, and recently there have been various studies on improvement of shaving performance assisting the blade as well as on improvement of functions of the blade. For example, there are a lubricating band and a guard bar. The lubricating band assists continuous maintenance of moisture of body hair, and the guard bar enables the blade to stand before cutting the body hair so that the blade is closed adhered to the skin and cuts the body hair deeply and efficiently.

However, even if such assistance is used, the strength of the body hair itself is not reduced, and thus the skin irritation may not be reduced while shaving. Hot water is used to reduce the skin irritation while shaving, but there arises a problem that nothing can detect a proper water temperature, display the water temperature and recognize whether the water temperature is proper.

### DISCLOSURE

### Technical Problem

The present invention has been made to solve the problems and it is an object of the present invention to provide a razor the color of which changes in accordance with water temperature.

### Technical Solution

In order to achieve the object of the present invention, a razor which comprises a razor cartridge to which a plurality of blades is coupled, and a handle coupled to the cartridge, wherein a temperature-sensitive capsule is embedded in the cartridge or in the handle such that the color of the temperature-sensitive capsule changes when the water temperature becomes higher than a specific temperature level.

The temperature-sensitive capsule comprises a leuco dye, a coloring agent and a wax.

The temperature-sensitive capsule changes in color at a melting point or higher of the wax.

The temperature-sensitive capsule reacts and changes in color at 25° C. or higher.

The temperature-sensitive capsule comprises a first wax ingredient with a first melting point and a second wax ingredient with a second melting point, and

changes into a first color at the first melting point or higher, and changes into a second color at the second melting point or higher.

The cartridge comprises a lubricating band which assists continuous maintenance of moisture of the body hair and a guard bar which is closely adhered to the skin and enables the body hair to stand before the blade cuts the body hair, and the temperature-sensitive capsule is embedded in the lubricating band or the guard bar.

### Advantageous Effect

As described above, a razor according to the present invention changes in color in accordance with water temperature.

Also, a razor according to the present invention enables a user to visually check whether water temperature is suitable for shaving, and to adjust the water temperature to a temperature suitable for shaving. Accordingly, a user may neatly and smoothly shave with adjustment of the water temperature.

### BRIEF DESCRIPTION OF DRAWINGS

FIG. 1 is an exploded perspective view of a razor cartridge according to the present invention.

FIG. 2 is a graph showing a cutting effect test performed in hot water.

### BEST MODE

The present invention provides a wet razor the color of which changes in accordance with water temperature as a temperature-sensitive capsule is embedded therein. The temperature-sensitive capsule may be embedded in all parts of the razor except in a blade.

Hereinafter, exemplary embodiments of the present invention will be described with reference to accompanying drawings.

A wet razor includes a cartridge to which a plurality of blades is coupled, and a handle.

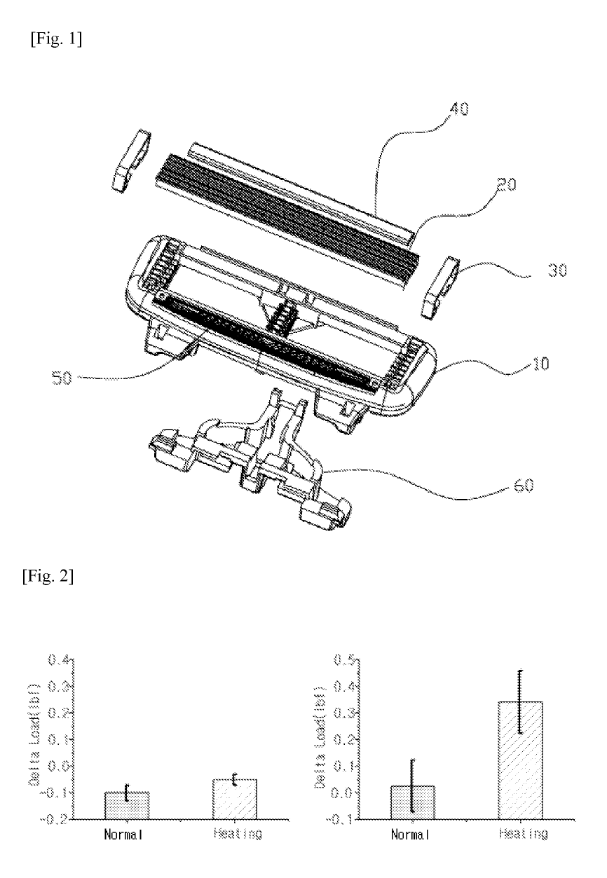

FIG. 1 is an exploded perspective view of a cartridge of the razor.

Referring to FIG. 1, the razor includes a cartridge body 10, a blade 20 which is installed in the cartridge body 10, a clip 30 which fixes both ends of the blade 20, a lubricating band 40 which is provided in a rear side of the blade 20, a guard bar 50 which is provided in a front side of the blade 20, and a connector 60 which connects the cartridge body 10 and a handle.

The clip 30 presses the blade 20 from the top and prevents the blade 20 from being detached from the cartridge body 10.

The lubricating band 40 is used to reduce the friction with the skin and to moisturize the skin. A shaving adjuvant is embedded in the lubricating band 40, and various materials may be embedded therein according to purposes. For example, a lubricant, a beard softening agent, a razor purifier, a medical agent, a cosmetic agent, or a combination of the foregoing may be embedded therein to improve the shaving performance. A soluble shaving adjuvant such as polyethylene oxide may be mixed with a insoluble material such as polystyrene polymer to form an insoluble polymer/soluble shaving adjuvant complex.

The guard bar 50 is provided in a front side of the blade 20 and is closely adhered to the skin and enables the body hair to stand before the blade 20 cuts the body hair.

The temperature-sensitive capsule may be embedded in a cartridge body or a handle as well as in the lubricating band 40 or the guard 50.

The ingredient of the temperature-sensitive capsule may include leuco dye, coloring agent and wax. If the wax reacts to particular hot water and is melted at a particular temperature or higher, the coloring agent ingredient is divided from the leuco dye and changes in color. The coloring agent may be selected from various colors. A melting point Tm of the wax may be adjusted to set the temperature at which the color changes. Preferably, a wax whose melting point is 25° C. may be used so that the wax is melted at 25° C. or higher at which shaving performance improves.

The coloring agent may be used in two or more colors, and the wax may include a first wax having a first melting point and a second wax having a second melting point, both of which may be used simultaneously. For example, if the first melting point is 25° C., and the second melting point is 40° C., the color is changed to a first color at a water temperature ranging from 25° C. or more to less than 40° C., and changed to a second color at a water temperature of 40° C. or higher.

If an initial base is a red color and a blue coloring agent is added thereto, the wax is melted and changes into the color of the coloring agent ingredient at a water temperature of 25 C or more. In this case, the color may become purple which is the middle color of red and blue colors. If the first and second waxes are used, the color becomes more bluish at a water temperature of 40° C. or higher. The color of the coloring agent may be adjusted freely.

The rate of the wax which accounts for the emitted ingredient of the temperature-sensitive capsule may range from 0.5% to 2%.

Using the aforementioned temperature-sensitive capsule provides the following advantages.

Firstly, the cutting performance is improved. Such improvement of the cutting performance may be identified from the test result. FIG. 2 illustrates a test result of the cutting performance which was carried out by using wool. Wool has different absorption rate to moisture from the body hair, but has similar chemical structure. Thus, it may be assumed that the body hair would have similar results to those of wool.

The graph illustrates the value which is calculated by deducting the force applied while cutting with hot water from the force applied while cutting with cold water. To improve reliability of data, the test was conducted five times and the average value of the force applied with cold water was calculated and then the average of the force which was calculated by conducting the test six to eight times and then deducted.

It can be identified that the delta load is higher, and this is because more force is required with cold water and less force is required with hot water and the difference therebetween is larger.

It can be identified that such different is larger in dry wool than in wet wool.

Second, hardness of the guard bar changes according to temperature.

The table below shows the change of hardness according to change of temperature.

TABLE 1

| | Set temperature | | |
|---|---|---|---|
| | 10° C. | 30° C. | 55° C. |
| Hardness | 42.2 | 39.3 | 37.2 |

As shown in the data above, the hardness of the guard bar is reduced as the temperature rises. According to previous user tests, the guard bar may be formed to grant maximized softness to the skin by freely being bent and through low hardness.

Third, softness increases as the modulus of the body hair decreases.

Regarding a compressive load to time which occurs when the blade cuts the body hair, the modulus value of wool in accordance with use of hot water in the cutting test decreases, and softness increases. If softness to the skin increases, the skin irritation may be reduced.

As above, using hot water may improve the shaving performance. If the razor according to the present invention includes the temperature-sensitive capsule to react to hot water, a user may visually check whether the water temperature is suitable for shaving, and enjoy more comfortable shaving.

1. A razor which comprises a razor cartridge to which a plurality of blades is coupled, and a handle coupled to the cartridge, wherein a temperature-sensitive capsule is embedded in the cartridge or in the handle such that the color of the temperature-sensitive capsule changes when the water temperature becomes higher than a specific temperature level.

2. The razor according to claim 1, wherein the temperature-sensitive capsule comprises a leuco dye, a coloring agent and a wax.

3. The razor according to claim 2, wherein the temperature-sensitive capsule changes in color at a melting point or higher of the wax.

4. The razor according to claim 1, wherein the temperature-sensitive capsule reacts and changes in color at 25° C. or higher.

5. The razor according to claim 1, wherein the temperature-sensitive capsule comprises a first wax ingredient with a first melting point and a second wax ingredient with a second melting point, and changes into a first color at the first melting point or higher, and changes into a second color at the second melting point or higher.

6. The razor according to claim 1, wherein the cartridge comprises a lubricating band which assists continuous maintenance of moisture of the body hair and a guard bar which is closely adhered to the skin and enables the body hair to stand before the blade cuts the body hair, and the temperature-sensitive capsule is embedded in the lubricating band or the guard bar.
